(19) United States
(12) Patent Application Publication
(10) Pub. No.: US 2007/0256294 A1
(43) Pub. Date: Nov. 8, 2007

(54) Piston for Automatic Speed Changer

(75) Inventors: Hirofumi Onishi, Aichi-ken (JP); Yuji Yasuda, Aichi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toyota Jidosha Kabushiki Kasiha, Toyota-shi (JP)

(21) Appl. No.: 11/568,844

(22) PCT Filed: May 13, 2005
(86) PCT No.: PCT/JP05/09207

§ 371 Date: Nov. 8, 2006

(30) Foreign Application Priority Data
May 14, 2004 (JP) 2004-145276

(51) Int. Cl. B23P 19/02

(52) U.S. Cl. 29/700

(57) ABSTRACT

A piston for an automatic transmission including a cylindrical portion and a bottom portion formed integrally with one of opposite axial end portions of the cylindrical portion and being formed by a press-forming operation, including a lug formed on the cylindrical portion by cutting and radially outwardly raising a predetermined circumferential portion of the cylindrical portion, so that the lug engages with a predetermined stationary member. The cylindrical portion includes a cutout formed in a circumferential part thereof, and a rotary member that rotates about an axis parallel to an axis of the piston is disposed in the cutout.

### TECHNICAL FIELD

The present invention relates to a piston for an automatic transmission, especially, to an improvement manufactured by a press-forming operation.

### RELATED ART

There is known a piston to be provided in the automatic transmission for operating such as a clutch or a brake. Such a piston is manufactured by a press-forming operation because the press-forming operation provides the piston at a lower cost and requires a relatively small space for the installation of the piston in the automatic transmission. JP 11-193830 A, Patent Document 1, and JP 2002-250364 A, Patent Document 2, for example, disclose such a piston for the automatic transmission.

JP 1-193830 A discloses a piston incorporating a cylindrical portion and a bottom portion formed integrally with one of opposite axial end portions of the cylindrical portion. The bottom portion cooperates to define a hydraulic chamber. And a flange portion is formed at another end portion of the cylindrical portion. The flange portion at the end of the cylindrical portion presses the clutch plate when working oil is supplied into the hydraulic chamber. This kind of piston is manufactured at a low cost because it is provided by the press-forming operation using a sheet metal. Furthermore, it is also advantageous in effective utilization of space such that the bottom portion cooperating to define a hydraulic chamber can be disposed in other space than a space nowhere the end portion, or the flange portion, of the cylindrical portion to press the friction plates is disposed.

There may be a case requiring restricting a rotation in the piston manufactured by the press-forming operation and incorporating the cylindrical and bottom portions. For example, it is the case in that a cutout is formed on a circumferential part of the cylindrical portion and other member is disposed in the cutout for an advantage in effective utilization of space. In this case, it is necessary to restrict the rotation of the piston since the different position of the cutout from the appropriate position may cause an interference of the piston with the member disposed in the cutout of the cylindrical portion. There is generally a slight allowance in a circumferential direction between the friction plates and a support member which supports the friction plates and restricts a relative rotation of the friction plates. As the allowance causes a rotation of the piston by a distance corresponding to the allowance when the piston presses the friction plates, there may be a disadvantage to suffer from a plenty of such a rotation and the sum of the rotation, namely, the piston rotates to a large extent as a result of the sum of a little bit of rotations, after the piston repeatedly presses the friction plates. For this reason, it is necessary to provide a structure to restrict a rotation in the piston.

To prevent such a disadvantage, it is considered that a lug is the effective structure to restrict the rotation of the piston. The lug radially outwardly extends from the cylindrical portion to engage with a predetermined stationary member. However, it causes manufacturing the piston at a high cost with providing a larger material enough to form the unit of not only the cylindrical portion but also the lug when the lug, as a structure to restrict the rotation, is formed on the end of the cylindrical portion.

The present invention was made in view of the background art described above. It is an object of the present invention to provide a piston for an automatic transmission having a structure to restrict the rotation thereof and manufactured at a low cost.

### SUMMARY OF THE INVENTION

The object indicated above may be achieved according to a first aspect of the invention, which provides a piston for an automatic transmission including a cylindrical portion and a bottom portion formed integrally with one of opposite axial end portions of the cylindrical portion, and being formed by a press-forming operation, the piston being characterized by comprising a lug which is formed on the cylindrical portion by cutting and radially outwardly raising a predetermined circumferential portion of the cylindrical portion so that the lug engages with a predetermined stationary member.

According to the first aspect of the invention, since the lug functioning as a member to restrict or stop a rotation of the piston is formed on the piston by press-forming operation to cut and radially outwardly raise a predetermined circumferential portion of the cylindrical portion, it is not necessary to provide a larger material for the piston to form the lug. Accordingly, the piston even having the rotation-restricting structure can be manufactured at a lower cost.

The object indicated above may be achieved according to a second aspect of the invention, which provides the piston according to the first aspect of the invention, wherein the piston is movable in the axial direction so that the piston presses friction plates disposed between a rotary member and the stationary member. According to the second aspect of the invention, a brake is operated with engagement of the friction plates by the piston of which the rotation about the axis is restricted or stopped by the lug.

The object indicated above may be achieved according to a third aspect of the invention, which provides the piston according to the first or second aspect of the invention, wherein the cylindrical portion includes a cutout formed in a circumferential part thereof, and wherein a rotary member which rotates about an axis parallel to an axis of the piston is disposed in the cutout. According to the third aspect of the invention, the cutout prevents an interference of the cylindrical portion of the piston of which the rotation about the axis is restricted or stopped by the lug, with mutually meshing circumferential portions of a counter drive gear and a counter driven gear.

The object indicated above may be achieved according to a fourth aspect of the invention, which provides the piston according to the second or third aspect of the invention, wherein the stationary member is disposed on a side of the lug in the rotary direction when the friction plates are operated. According to the fourth aspect of the invention, it is provided a necessary and sufficient structure for restricting or stopping the rotation and an uncomplicated structure of the rotation-restricting device for the piston.

The object indicated above may be achieved according to a fifth aspect of the invention, which provides the piston according to the fourth aspect of the invention, wherein the stationary member includes an engaging projection having an engaging surface parallel to the axis of the piston, and wherein the lug is abutted to the engaging surface for allowing an axial movement of the piston. According to the fifth aspect of the invention, the rotation of the piston is restricted or stopped allowing the axial movement of the piston.

### BRIEF DESCRIPTION OF THE DRAWINGS

FIG. 1 shows a sectional view of a part of an automatic transmission including a piston of an embodiment according to the present invention; and

FIG. 2 shows a sectional view of a part of the automatic transmission from the direction II-II in FIG. 1.

### REFERENCE NUMERALS

10: Clutch device
12: Casing (Stationary member)
16: Counter drive gear (Rotary member)
26: Piston
28: Cylindrical portion
30: Bottom portion
46: Inwardly extending friction plates
50: Outwardly extending friction plates
52: Lug
56: Projection for engagement
56a: Engaging surface
58: Counter driven gear (Rotary member)
60: Cutout

### DETAILED DESCRIPTION OF EXEMPLARY EMBODIMENTS

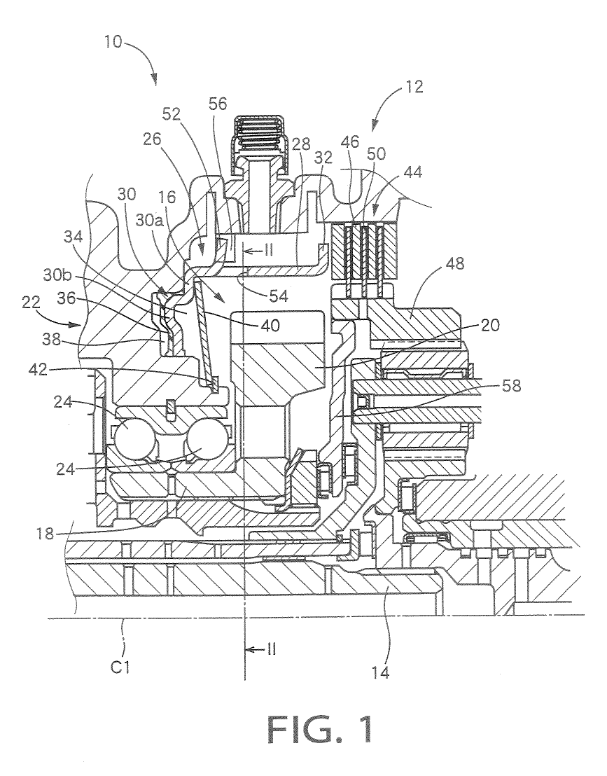

Hereinafter, there will be described the present invention by reference to the drawings. Referring first to the cross sectional view of FIG. 1, there is shown a portion an upper half portion of the apparatus over the axis C1, of an automatic transmission 10 for a vehicle which includes a piston 26 constructed according to one embodiment of this invention. The axis C1 is denoted by an alternate long and short dashed line.

As shown in FIG. 1, the automatic transmission 10 includes a stationary member in the form of a casing 12, an input shaft 14 extending through the casing 12, and a counter drive gear 16 mounted on the input shaft 14 such that the counter drive gear 16 is rotatable relative to the input shaft 14. The counter drive gear 16 consists of a cylindrical shaft portion 18 parallel to and fitted on the outer circumferential surface of the input shaft 14, and a gear portion 20 formed at one axial end portion of the cylindrical shaft portion 18 such that the gear portion 20 extends radially outwardly of the cylindrical shaft portion 18. The input shaft 14 and the counter drive gear 16 are coaxial with each other on the axis C1.

The casing 12 includes a support wall 22, which has a bore in which bearings 24 are fitted, to support the counter drive gear 16 at its cylindrical shaft portion 18, such that the counter drive gear 16 is rotatable relative to the support wall 22, and such that the support wall 22 is located adjacent to the gear portion 20 in the axial direction of the counter drive gear 16.

The piston 26 also coaxial with the input shaft 14 on the axis C1 is disposed radially outwardly of the counter drive ear 16. This piston 26 is formed from one metal plate such as a steel plate using a press die by a press-forming operation. The piston 26 consists of a cylindrical portion 28 as a covering wall disposed radially outwardly of the gear portion 20 of the counter drive gear 16, a bottom portion 30 as a bottom wall formed integrally with one of opposite axial end portions of the cylindrical portion 28 on the side of the support wall 22, and a flange portion 32 bent and extending radially outwardly from the other axial end portion of the cylindrical portion 28 at which the flange portion 32 presses a brake 44 described later. The bottom portion 30 takes the form of a ring or a flange extending radially inwardly from the cylindrical portion 28, and consists of a radially outer portion 30a and a radially inner portion 30b formed as extending in the axial direction toward the support wall 22. The radially inner portion 30b of the bottom portion 30 is axially slidably received in an annular recess 34 formed in the support wall 22 such that the annular recess 34 is open toward the gear portion 20 of the counter drive gear 16.

A sealing rubber member 36 is bonded to an outer surface of the radially inner portion 30b of the bottom portion 30 which is opposed to the support wall 22. The sealing rubber member 36 provides fluid tightness between the bottom portion 30 and the support wall 22, at the radially inner and outer edges of the radially inner portion 30b of the bottom portion 30. The sealing rubber member 36 cooperates with the annular recess 34 to define a hydraulic chamber 38. A coned-disc return spring (Belleville spring) 40 is fixedly disposed at the open end of the annular recess 34 of the support wall 22, such that the coned-disc return spring 40 biases the bottom portion 30 of the piston 26 in the aria direction toward the hydraulic chamber 38 (in the left direction as seen in FIG. 1). The coned-disc return spring 40 is held at its radially outer portion in abutting contact with the inner surface of the radially outer portion 30a of the bottom portion 30, and at its radially inner portion in engagement with a retainer spring 42 which is fixed to the support wall 22. The retainer spring 42 prevents an axial movement of the coned-disc return spring 40 toward the counter drive gear 16.

The automatic transmission 10 incorporates the brake 44 opposed to the flange portion 32 of the piston 26 in the axial direction of the piston 26 in the casing 12. The brake 44 functions as a set of frictional coupling elements to restrict or stop the rotation of the ring gear 48. The brake 44 includes a plurality of radially inwardly extending friction plates 46 splined to the inner circumferential surface of the casing 12 such that the friction plates 46 are axially movable relative to the casing 12 and not rotatable with the casing 12. The brake 44 further includes a plurality of radially outwardly extending friction plates 50 splined to the outer circumferential surface of the casing 12 such that the friction plates 50 are axially movable relative to the casing 12 and not rotatable with the casing 12, and such that each radially outwardly extending friction plate 50 is interposed between the adjacent radially inwardly extending friction plates 46.

A lug or jaw or protrusion 52 is formed on the piston 26 by a press-forming operation to cut and radially outwardly raise a predetermined circumferential portion of the cylindrical portion 28. The lug 52 functions as a member to restrict to stop a rotation of the piston 26. And an aperture 54 is also formed on the piston 26 as a result of raising the lug 52. The lug 52, for example, is a form of a band having the predetermined width and length, and has a smaller dimension than that between the outer circumferential surface of the cylindrical portion 28 and the inner surface of the casing 12, namely, is short sufficient not to reach the inner surface of the casing 12.

A projection 56 integrally extends from the inner surface of the casing 12 so that an engaging surface 56a of the projection 56 on the side in the rotating direction of the ring gear 48 (as viewed on the opposite side of this side in FIG. 1), namely, in the rotating direction of the outwardly extending friction plates 50 when the brake 44 operates, engages a surface of the lug 52. The integral member including the casing 12 and the projection 56 corresponds to the stationary member.

As described above, the projection 56 incorporates the engaging surface 56a so that the engaging surface 56a engages with the surface of the lug 52. The engaging surface 56a is a flat surface formed as parallel to the axis C1, and allows the parallel movement to the axis C1 of the piston 26.

The aperture 54 functions as a lubrication hole through which a lubricant for lubricating the counter drive gear 16 in the piston 26 flows in the radially outward direction of the cylindrical portion 28. This radially outward flow of the lubricant through the aperture 54 results in a decrease in the volume of the lubricant to be agitated by a rotary motion of the counter drive gear 16, making it possible to reduce a power loss due to the agitation. There may be formed further one or a plurality of lubrication holes by punching on a part of the cylindrical portion 28 in the case that the insufficient amount of the lubricant is exhausted through only the aperture 28.

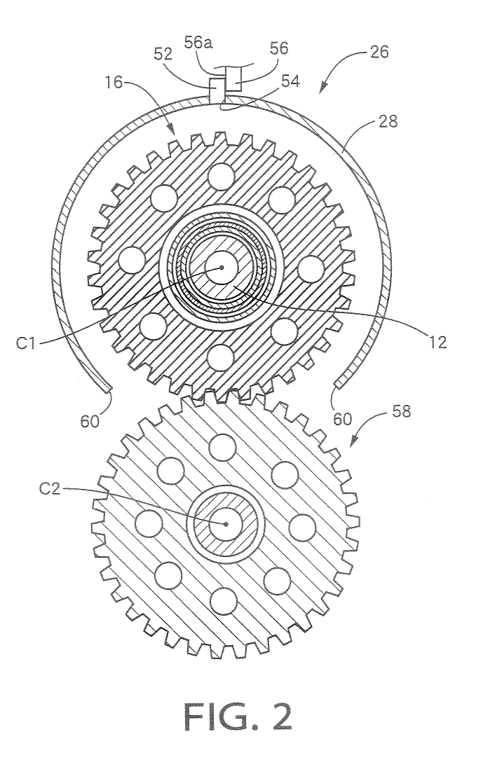

Referring next to FIG. 2 of the sectional view from the direction II-II in FIG. 1, the cylindrical portion 28 of the piston 26 covers a most of the circumference of the counter drive gear 16. However, the cylindrical portion 28 has a cutout 60 formed in a circumferential part thereof corresponding to a circumferential position of the counter drive gear 16 at which the counter drive gear 16 meshes with a counter driven gear 58, for example, the range on the circumference of the cutout 60 corresponds to the circumferential angle of approximately 90 degrees about the axis C1. The counter driven gear 58 is mounted on a shaft having another axis C2 parallel to the input shaft 14 having the axis C1 on which the counter drive gear 16 is mounted. The counter driven gear 58 is rotatable with respect to the axis C2. The cutout 60 permits mutual meshing engagement of the counter drive and driven gears 16, 58 such that a point of the meshing engagement is located within the circumference (more precisely, the inner circumferential surface) of the cylindrical portion 28 of the piston 26.

In the automatic transmission 10 constructed thus, when the working oil is supplied into the hydraulic chamber 38, the piston 26 is moved against the biasing force of the coned-disc return spring 40, then the flange portion 32 of the piston 26 presses the inwardly extending friction plates 46, accordingly, the inwardly and outwardly extending friction plates 46, 50 engage with each other and the rotation of the outwardly extending friction plates 50 is restricted or stopped. At that time, due to a slight allowance in the circumferential direction between the casing 12 and the inwardly extending friction plates 46, the inwardly extending friction plates 46 is permitted to rotate by the slight allowance. As a result, the piston 26 which presses the inwardly extending friction plates 46 receives a torque or rotating force in the rotating direction. However, since the lug 52 formed in the piston 26 engages with the projection 56, namely, the circumferential movement of the lug 52 is restricted or stopped by the projection 56 as described above, the piston 26 is hindered or prevented from rotating.

According to the present embodiment of the invention, since the lug 52 functioning as a member to restrict or stop a rotation of the piston 26 is formed on the piston 26 by press-forming operation to cut and radially outwardly raise a predetermined circumferential portion of the cylindrical portion 28, it is not necessary to provide a larger material for the piston 26 to form the lug 52. Accordingly, the piston 26 even having the rotation-restricting structure can be manufactured at a lower cost.

According to the present embodiment of the invention, since the piston 26 is driven in the axial direction of C1 for pressing the inwardly and outwardly extending friction plates 46, 50 of the brake 44 mounted between the counter drive gear 16 as the rotary member and the casing 12 as a stationary member, the brake 44 is operated with engagement of the friction plates 46, 50 by the piston 26 of which the rotation about the axis C1 is restricted or stopped by the lug 52.

According to the present embodiment of the invention, since the piston 26 has the cutout 60 formed in a circumferential part of the cylindrical portion 28 thereof corresponding to a circumferential position of the counter drive gear 16 at which the counter drive gear 16 meshes with the counter driven gear 58, and the counter driven gear 58 as a rotary member is rotatable about the axis C2 and mounted on a shaft having the axis C2 parallel to the input shaft 14 having the axis C1 on which the counter drive gear 16 is mounted, the cutout 60 prevents an interference of the cylindrical portion 28 of the piston 26 of which the rotation about the axis C1 is restricted or stopped by the lug 52 with mutually meshing circumferential portions of the counter drive gear 16 and the counter driven gear 8.

According to the present embodiment of the invention, since the casing 12 corresponding to the stationary member is disposed on the rotation side of the lug 52 upon the engaging operation of the brake 44, it is provided a necessary and sufficient structure for restricting or stopping the rotation and an uncomplicated structure of the rotation-restricting device for the piston 26.

According to the present embodiment of the invention, since the casing 12 corresponding to the stationary member has the engaging projection 56 having a engaging surface 56a parallel to the axis C1 of the piston 26, and the lug 52 engages with or is abutted on the engaging surface 56a and allows the axially movement of the piston 26 in the direction of C1, the rotation of the piston 26 is restricted or stopped allowing the axial movement of the piston 26.

While the present invention has been described in its exemplary embodiment with reference to the drawings, it is to be understood that the present invention may be embodied otherwise.

For example, while the lug 52 is formed by press-forming operation to cut and radially outwardly raise a predetermined circumferential portion of the cylindrical portion 28 and engages with the projection 56 of the casing 12 corresponding to the stationary member in the above-described embodiment, the lug 52 may be formed by cutting and radially inwardly raising a predetermined circumferential portion in the case that the stationary member is formed inside the piston 26, so that the lug 52 engages with the projection 56 formed on the stationary member inside the piston 26.

While the projection 56 is integrally protruded from the radially inner surface of the casing 12 to engage with the lug 52 in the rotating direction of the outwardly extending friction plates 50 upon the operation of the brake 44 in the above-described embodiment, the projection may be formed to engage with the lug 52 on the side or sides in both or either the rotating direction and/or the counter rotating direction. While the projection 56 is integrally formed with the casing 12 in the embodiment, it may be formed by another member which is not integrally formed with the casing 12 and fixed on the inner surface of the casing 12.

While the counter drive gear 16 is disposed in the cutout 60 of the cylindrical portion 28 of the piston 26 in the above-described embodiment, any other member may be disposed in the cutout 60 than the counter drive gear 16.

While it is necessary to restrict or stop the rotation of the piston 26 because the counter drive gear 28 is disposed in the cutout 60 formed on the cylindrical portion 28 in the above-described embodiment, other various reasons to restrict or stop the rotation of the piston 26 may be considered, not limited to the reason in the above-described embodiment. The present invention may be adopted for any piston manufactured by the press-forming operation which requires the structure for restricting or stopping the rotation, irrespective of a reason for requiring the structure for restricting or stopping the rotation.

While the lug 52 is formed only at one place in the above-described embodiment, a plurality of the lugs 52 may be formed at a plurality of places. And various shapes of the lug 52 may be adopted, not limited to a shape of a band.

While the piston 26 is slidably received in the annular recess 34 formed on the casing 12 corresponding to the stationary member in the above-described embodiment, the piston 26 may be slidably received in the annular recess 34 formed on a member which is relatively unrotatable with respect to the piston 26. The “stationary member” means a member which is relatively unrotatable with respect to the piston 26.

It is to be understood that the present invention may be embodied with other changes, improvements, and modifications that may occur to a person skilled in the art without departing from the scope and spirit of the invention defined in the appended claims.

1: A piston for an automatic transmission including a cylindrical portion and a bottom portion formed integrally with one of opposite axial end portions of the cylindrical portion, and being formed by a press-forming operation, the piston comprising:
a lug which is formed on the cylindrical portion by cutting and radially outwardly raising a predetermined circumferential portion of the cylindrical portion, so that the lug engages with a predetermined stationary member; and
a cutout which is formed in a circumferential part of the cylindrical portion,
wherein a rotary member which rotates about an axis parallel to an axis of the piston is disposed in the cutout.

2: The piston according to claim 1, wherein the piston is movable in the axial direction so that the piston presses friction plates disposed between a rotary member and the stationary member.

3-5. (canceled)

6: The piston according to claim 1, wherein the stationary member is disposed on a side of the lug in the rotary direction when the friction plates are operated.

7: The piston according to claim 2, wherein the stationary member is disposed on a side of the lug in the rotary direction when the friction plates are operated.

8: The piston according to claim 6, wherein the stationary member includes an engaging projection having an engaging surface parallel to the axis of the piston, and wherein the lug is abutted to the engaging surface for allowing an axial movement of the piston.

9: The piston according to claim 7, wherein the stationary member includes an engaging projection having an engaging surface parallel to the axis of the piston, and wherein the lug is abutted to the engaging surface for allowing an axial movement of the piston.
